(19) United States
(12) Patent Application Publication
(10) Pub. No.: US 2006/0290498 A1
(43) Pub. Date: Dec. 28, 2006

(54) Incorporation of RFID devices into labels

(75) Inventors: Timothy W. Rawlings, Waynesville, OH (US); Wendell B. Halbrook JR., Waynesville, OH (US)

Correspondence Address: DOUGLAS S. FOOTE;NCR CORPORATION, 1700 S. PATTERSON BLVD. WHQ5E, WHO-5E, DAYTON, OH, 45479, US

(73) Assignee: NCR Corporation

(21) Appl. No.: 11/159,450

(22) Filed: Jun. 23, 2005

(51) Int. Cl. G08B 13/14

(52) U.S. Cl. 340/572.1

(57) ABSTRACT

A label of the type bearing an RFID device, and removably attached to a backing liner. A cavity is formed in the label, the liner, or both. The RFID device is positioned in the cavity. If the RFID device were not placed into the cavity, but merely laminated between the label and the liner, then the RFID device would create a bulge. Processing steps which apply pressure would then apply large pressure at the bulge, perhaps damaging the RFID device.

### BACKGROUND OF THE INVENTION

FIG. 1 illustrates peel-off labels 3, which are attached to a backing liner 6, containing perforations 9 which cooperate with a tractor-feed mechanism (not shown) which can be used to move the liner 6 during manufacture, or later during printing, or both. Sandwiched between each label 3 and the liner 6 is an RFID, Radio Frequency IDentification, device 12, together with one or more antennas 15. The antennas can take the form of thin wires, or conductive foil. The combination of the RFID chip 12 and the antenna, when positioned between the label 3 and the liner 6, is commonly called an “inlay.”

A typical RFID device stores data, and when it receives an incoming rf interrogation signal from a transceiver, it transmits the data to the transceiver. For example, an RFID device can be attached to a shipping container, and the data may indicate (1) point of origin, (2) destination, (3) contents, and so on. RFID devices are convenient because the transceiver can retrieve the data without physically connecting with the RFID device, and also because, with some RFID devices, the transceiver can be located some distance from the RFID device.

A problem can arise during manufacture of the labels 3 in FIG. 1. FIG. 2 is a cross-sectional view, showing how the RFID device 12 can increase the thickness T of the label-liner combination. This increase in thickness can increase likelihood of damage to the RFID device 12 during manufacture, as will be explained with reference to FIG. 3.

FIG. 3 is a simplified schematic of a manufacturing process where the labels 3 are attached to the liner 6. If the RFID devices are installed at point 18, subsequent processing steps occur. These include, for example, printing, coating, laminating, slitting, perforating, and die cutting processes. These processes can damage the RFID devices. For example, many printing processes utilize rollers which apply high pressure to the labels. Plainly, in the case of FIG. 2, the high pressure will be concentrated on the bump created by the RFID device 12, and can damage the device 12.

The present invention offers a stratagem for eliminating such damage.

### OBJECTS OF THE INVENTION

An object of the invention is to provide an improved RFID label.

A further object of the invention is to provide an improved process of manufacturing labels bearing RFID devices, in which damage to the devices is reduced.

### SUMMARY OF THE INVENTION

In one form of the invention, a cavity is created in a laminated stack of sheets. An RFID device is inserted into the cavity, thereby incorporating the RFID device into the stack, but without increasing the thickness of the stack.

### BRIEF DESCRIPTION OF THE DRAWINGS

FIG. 1 illustrates a prior-art system of labels, wherein an RFID inlay is held between the labels 3 and a liner 6.

FIG. 2 is a cross-sectional view of one label in FIG. 1.

FIG. 3 is a simplified schematic of a process in which the labels of FIG. 1 are manufactured.

FIGS. 4, 5, and 8 illustrate a sequence of processing events undertaken in one form of the invention.

FIG. 6 is a perspective view of part of FIG. 5.

FIG. 7 is a cross-sectional view of FIG. 6.

FIGS. 9, 11, 12, and 13 illustrate different combinations of components utilized by several forms of the invention.

FIG. 10 illustrates adhesive layer 24.

FIGS. 14 and 15 illustrate sequences of processing steps used in fabricating the invention.

FIG. 16 illustrates a connecting lead 77 between the RFID device 12 and the antenna 15.

FIGS. 17 and 18 illustrate alternate configurations of the connecting lead 77.

FIG. 19 illustrates a sequence of processing steps undertaken by one form of the invention.

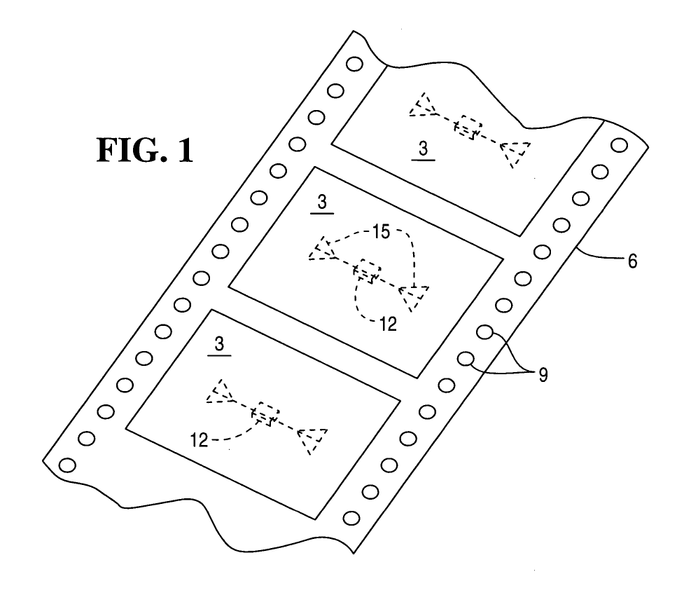

### DETAILED DESCRIPTION OF THE INVENTION

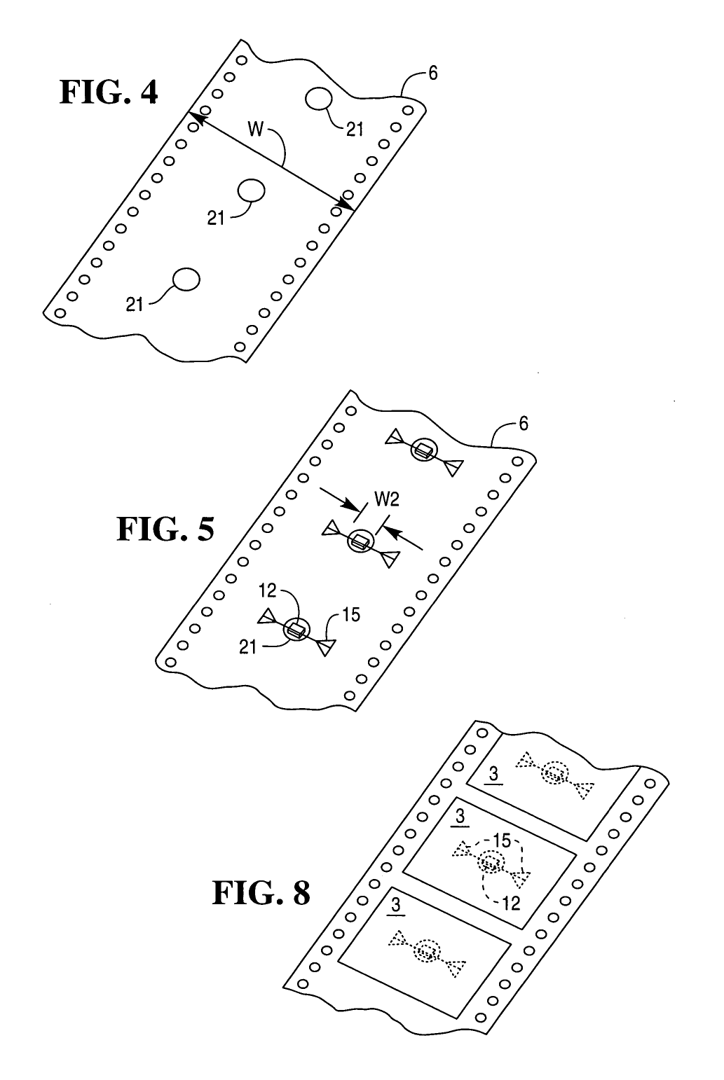

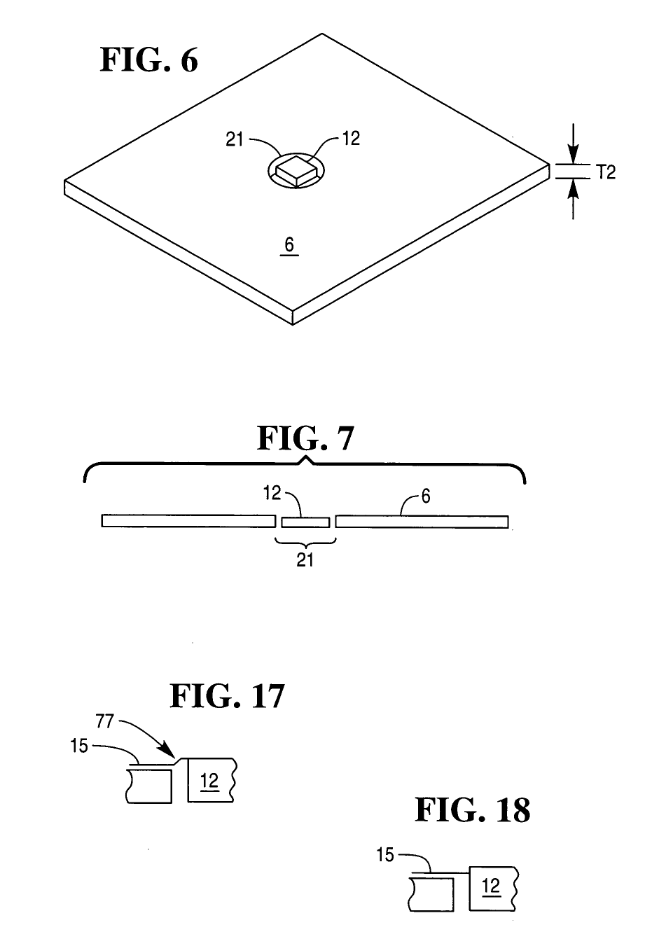

FIG. 4 illustrates a liner 6, in which through-perforations 21 are punched. FIG. 5 illustrates RFID devices 12 placed into the perforations 21, and the antennas 15 which flank the RFID device 12. FIG. 6 illustrates the situation in perspective view, without the antennas, and FIG. 7 illustrates the situation in cross-sectional view.

In FIG. 8, labels 3 are attached to the liner 6. As shown in FIG. 10, a layer of adhesive 24 is present, which performs three functions. One, it removably attaches the label 3 to the liner. Two, it attaches the RFID device to the label, Three, it attaches the antennas 15 in FIG. 8 to the label 3.

Under this arrangement, when the label 3 is peeled from the liner, both the antennas 15 and the RFID device 12 come along with the label, but for two different reasons. As to the RFID device 12, it follows the label 3 because it was not in contact with the liner, let alone adhered to the liner 6. As to the antenna 15, it follows the label 3 because, although it was in contact with the liner 6, there is no adhesive between the antennas 15 and the liner 6. The adhesive is between the antennas 15 and the label, adhering them together, and not adhering the antennas 15 to the liner 6.

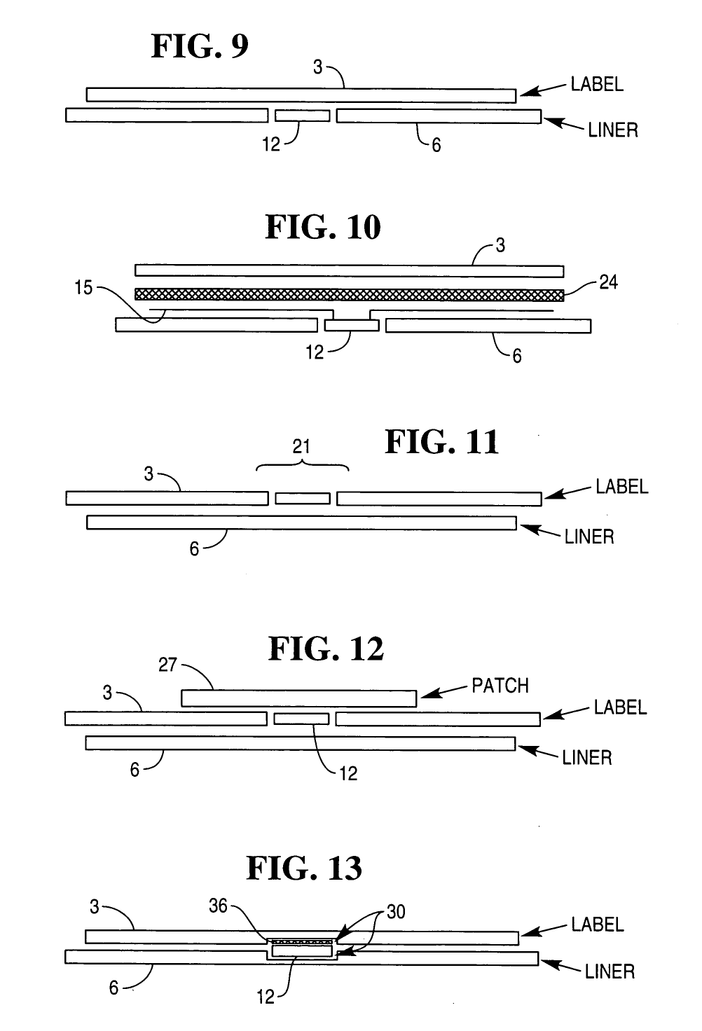

FIGS. 9 and 11-13 illustrate several different arrangements of components, as used by the invention. FIG. 9 illustrates the arrangement discussed above: the perforation 21 is within in the liner 6, and the RFID device 12 resides in the perforation.

In FIG. 11, the perforation 21 is formed in the label 3, rather than in the liner 6 as above. The antennas can be located between the label 3 and the liner 6. A patch 27 in FIG. 12 can be added, which can take the form of a self-adhesive label, which affixes the RFID device 12 to the label 3, and holds the RFID device 12 in place when the label 3 is removed from the liner 6.

FIG. 13 illustrates a situation where no perforation is used, but depressions 30 are formed in both the label 3 and the liner 6, which together form a cavity which contains the RFID device 12. Adhesive 36 attaches the RFID device 12 to the label 3. A similar adhesive (not shown) attaches the antennas (not shown) to the label 3.

In another embodiment, the antennas are installed at a different time than is the RFID device. One justification for the different installation times is that many antennas are sturdier than are the RFID devices. For example, if the antenna takes the form of a strip of foil, the strip can be in the approximate range of 0.001 to 0.005 inches thick. If such a strip is laminated between two layers of paper, the thickness is not increased appreciably, and the overall structure can withstand significant pressure and abuse.

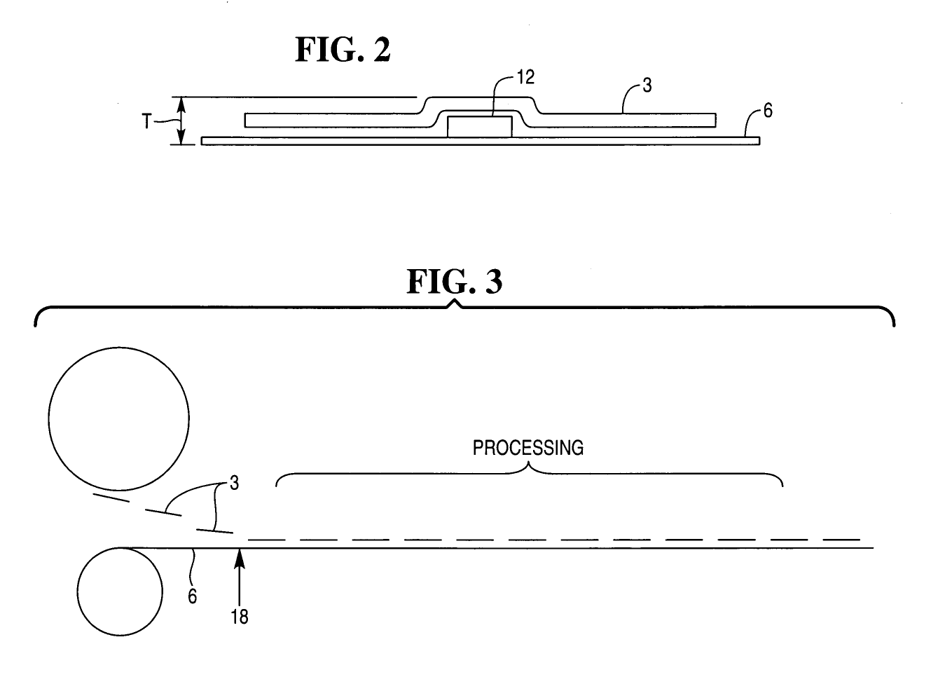

In contrast, if the RFID device is 0.1 inch thick, the situation becomes like that of FIG. 2, wherein resistance to pressure is not so great. One reason is that, if a roller is applying pressure, the pressure is distributed across the width of the liner, that is, across width W in FIG. 4. However, when the roller reaches the RFID device of FIG. 2, the entire force of the roller is concentrated over smaller width W2 in FIG. 5. The pressure, in units of force per unit width, becomes much larger.

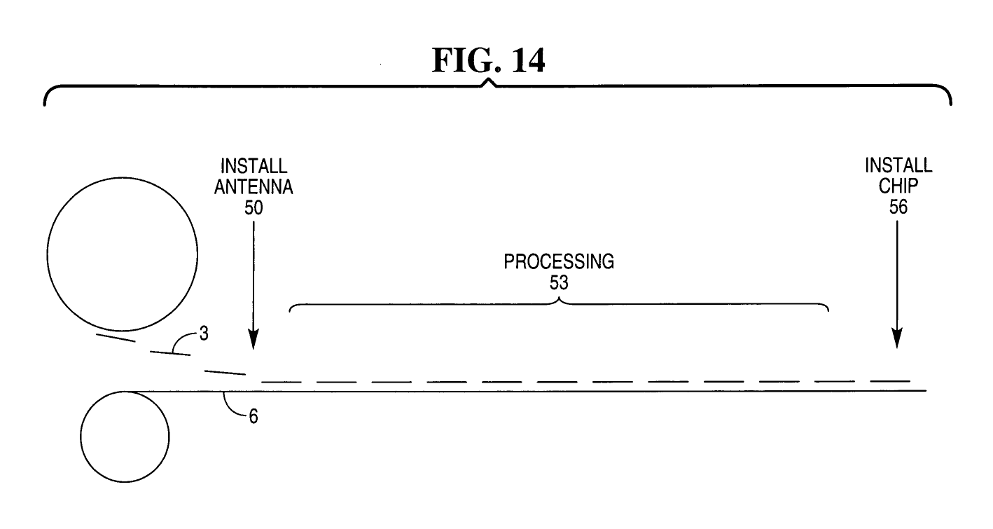

Since, under this reasoning, the antenna may be more robust than the RFID device, the antenna is installed prior to the RFID device. For example, in FIG. 14, the antenna is installed at point 50. Processing 53 is then undertaken, and then the RFID device, or chip, is installed at point 56.

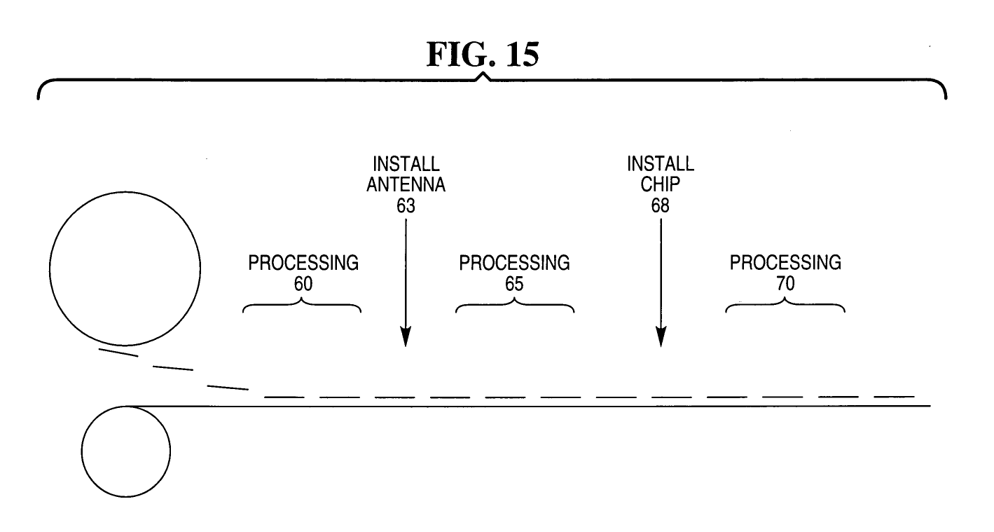

In the more general case, in FIG. 15, processing 60 occurs, then the antenna is installed at point 63. Other processing 65 follows, followed by installation of the RFID device, at point 68. Then further processing 70 may occur.

### Additional Considerations

1. The Inventors point out that, it is preferable that the RFID device be the same thickness as the sheet which surrounds it. For example, in FIG. 6, it is preferable that both the RFID device 12 and the liner 6 be of the same thickness T2.

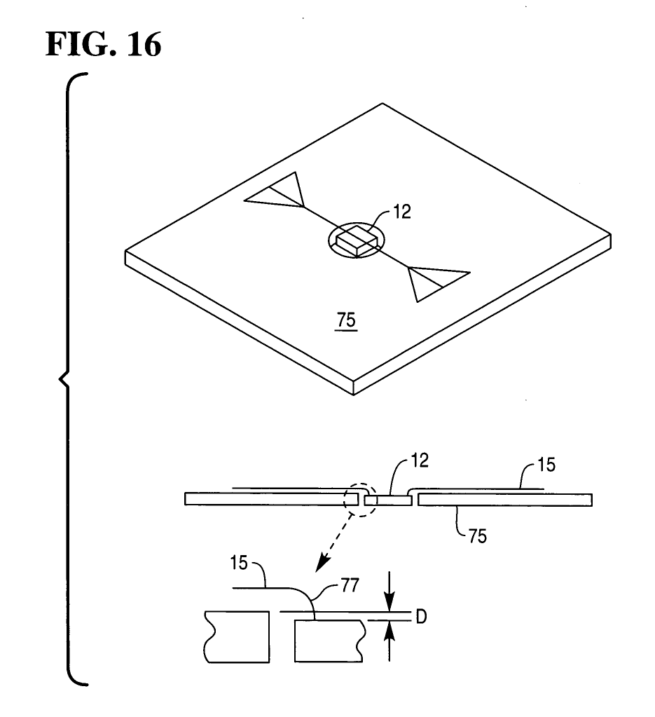

However, the RFID device and the liner, or label, may not be the same thickness. FIG. 16 illustrates one situation. The top of the Figure is a perspective view. The central part of the Figure is a cross-sectional view, and shows that the RFID device 12 is thinner than the sheet 75 surrounding it. Consequently, the conductive lead 77 which connects to the antenna 15 must bridge the difference D in height, as the magnified insert in the Figure shows.

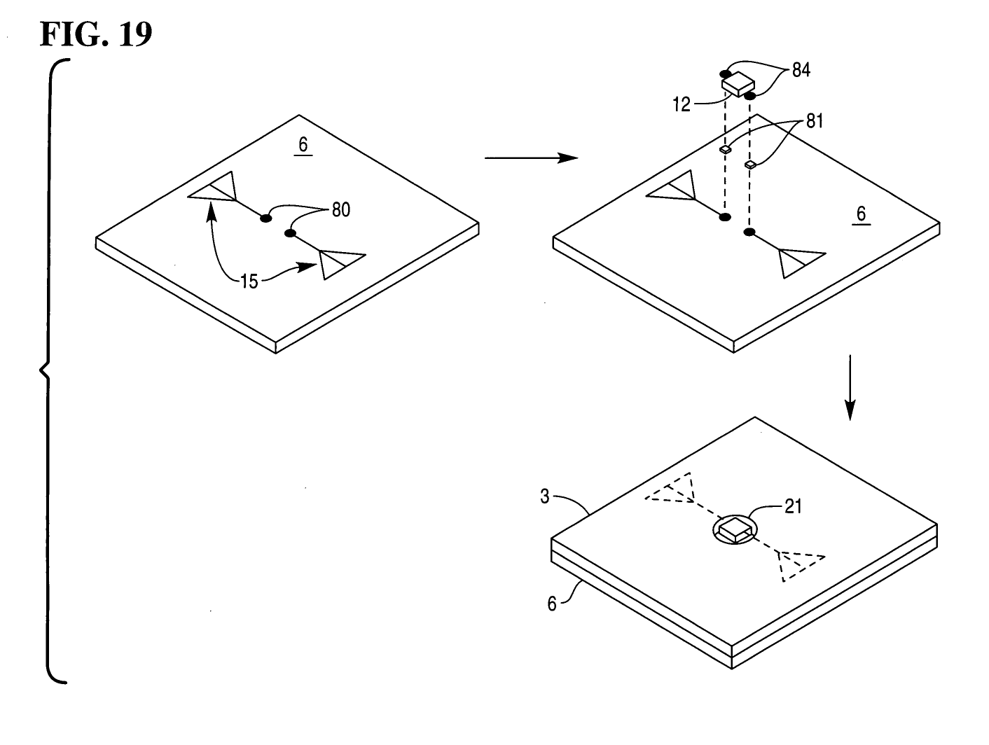

Similarly, if the RFID device is thicker than the sheet surrounding it, a conductive lead 82 in FIG. 17 must drop down to the level of the antenna.

In theory, the conductive lead between the antenna and the RFID chip can feed directly to the RFID chip, as in FIG. 18. However, in practice, such a feed is undesirable, because it increases cost. That is, the RFID chip will certainly be manufactured as an integrated circuit, probably on a silicon wafer. Since such circuits are fabricated layer-by-layer, it is more convenient to place signal contact pads within a layer, rather than at the edge of a layer. Edge-type positioning would be required in the case of FIG. 18.

2. FIG. 19 illustrates one sequence of assembly, wherein the antenna is installed prior to the RFID device. The sequence begins with backing liner 6. An antenna 15 is positioned on the liner 6, as indicated. Contact pads 80 are shown exaggerated in size, for emphasis.

RFID device 12 is then installed. Blocks 81 represent masses of a solder-like substance, used to make electrical contact between contact pads 84, on the RFID device 12, and the pads 80, on the antenna 15. A conductive adhesive, such as an epoxy filled with silver powder, can be used.

Then label 3, bearing perforation 21, is installed, as shown at the end of the sequence.

3. In one form of the invention, the labels under consideration are of the sheet-type, having a thickness in the range of 0.002-0.015 inches. This is to distinguish over articles such as hood ornaments and three-dimensional advertising signs, which could be considered labels, but are not manufactured using the processes which produce peel-off labels attached to a backing web, as described herein.

4. The labels under consideration can contain graphic images as well as textual information.

5. If the antenna is installed first, and the RFID device installed later, it is possible that no need exists for the perforations 21 shown in FIG. 4. That is, if the RFID device is installed after the potentially abusive processing steps, then the need for protecting the RFID device may disappear.

Accordingly, in one form of the invention, the antenna is installed first, then the potentially abusive processing is undertaken, followed by installation of the RFID device. In this form of the invention, the RFID device is laminated between the label and the liner, producing a structure as shown in FIG. 2.

Numerous substitutions and modifications can be undertaken without departing from the true spirit and scope of the invention. What is desired to be secured by Letters Patent is the invention as defined in the following claims.

1. Apparatus, comprising:
a) a lamination comprising
i) a label having a thickness T1;
ii) a liner having a thickness T2; and
iii) an RFID device having a thickness T3; and
b) means for causing total thickness of the lamination to be less than the sum of T1 plus T2 plus T3.

2. Apparatus according to claim 1, wherein the means comprises a recess in
i) the label,
ii) or in the liner, or
iii) in both the label and the liner.

3. Apparatus according to claim 2, and further comprising an antenna (1) electrically connected with the RFID device, and (2) outside the recess.

4. Apparatus according to claim 3, and further comprising
c) means for connecting the RFID device and the antenna to the label, such that, when the label is removed from the liner in normal use, the RFID device and the antenna remain with the label, and are removed from the liner.

5. Apparatus, comprising:
a) a liner sheet;
b) a sheet-label attached to the liner;
c) a recess in the label or the liner, or both; and
d) an RFID device within the recess.

6. Apparatus according to claim 5, and further comprising an antenna, outside the recess, electrically connected to the RFID device.

7. Apparatus, comprising:
a) a laminated stack, which includes at least a sheet-label attached to a sheet-liner;
b) a cavity in the laminated stack; and
c) an RFID device within the cavity.

8. Apparatus according to claim 7, and further comprising an antenna, electrically connected to the RFID device, and located outside the cavity.

9. Apparatus according to claim 7, further comprising:
d) connection means for connecting the RFID device to the sheet-label, such that when the sheet-label is removed from the sheet-liner, the RFID device remains attached to the sheet-label.

10. Apparatus, comprising:
a) an elongated backing liner;
b) a plurality of labels, removably attached to the backing liner, wherein
i) regions of Type A exist, at which a label-liner contact interface is present, and
ii) regions of Type B exist, at which no label-liner contact interface is present;
c) at each Type B region, an RFID device attached to a label.

11. A method of manufacturing labels, comprising:
a) making a recess in a liner, in a label, or in both;
b) placing an RFID device into the recess; and
c) adhering the label to the liner.

12. Method according to claim 11, wherein the process of adhering comprises using an adhesive which allows the label to be removed from the liner and to be re-attached to another surface.

13. Method according to claim 12, wherein the RFID device remains connected to the label upon removal from the liner.

14. A method of manufacturing a label, comprising:
a) positioning an antenna on a label, or a component adjacent the label;
b) performing processing steps upon the label, the component, or both; and then
c) attaching an integrated circuit to the antenna.

15. In a process of manufacturing labels, wherein processes are undertaken which likely damage integrated circuits attached to the labels, a method comprising:
a) installing an antenna in a label;
b) subjecting the label to said processes; and then
c) installing an integrated circuit in the label.

16. Process according to claim 15, wherein
i) the label is removably attached to a liner,
ii) a cavity is formed within the label, the liner, or both the label and liner, and
iii) the integrated circuit is contained within the cavity.

17. Process according to claim 16, wherein the integrated circuit is of the RFID type.

18. Process according to claim 15, wherein the integrated circuit is laminated between the label and the liner.

19. A method of fabricating a label, comprising
a) placing an antenna having a contact point on a first sheet;
b) placing an RFID device near the antenna, and making electrical contact between a contact pad on the RFID device and the contact point; and
c) adhering a second sheet to the first sheet.

20. Method according to claim 19, wherein the first and second sheets cooperate to form a cavity which contains the RFID device.

21. Method according to claim 19, and further comprising a conductive mass which electrically connects the contact point with the pad.
